(19) United States
(12) Patent Application Publication
(10) Pub. No.: US 2021/0293129 A1
(43) Pub. Date: Sep. 23, 2021

(54) PROCESS FOR REAL TIME GEOLOGICAL LOCALIZATION WITH KALMAN FILTERING

(71) Applicants: SHELL OIL COMPANY, HOUSTON, TX (US); WILLIAM MARSH RICE UNIVERSITY, Houston, TX (US)

(72) Inventors: Neilkunal PANCHAL, Houston, TX (US); Sami Mohammed Khair SULTAN, Houston, TX (US); Yinsen MIAO, Houston, TX (US); Marina VANNUCCI, Houston, TX (US); Daniel Ryan KOWAL, Houston, TX (US)

(21) Appl. No.: 17/264,012

(22) PCT Filed: Jul. 30, 2019
(86) PCT No.: PCT/US2019/044051

§ 371 Date: Jan. 28, 2021

Related U.S. Application Data
(60) Provisional application No. 62/712,722, filed on Jul. 31, 2018.

(51) Int. Cl. E21B 44/02; E21B 7/06

(52) U.S. Cl. CPC E21B 44/02; E21B 2200/20; E21B 7/06

(57) ABSTRACT

A method of geosteering in a wellbore construction process uses an earth model that defines boundaries between formation layers and petrophysical properties of the formation layers in a subterranean formation. Sensor measurements related to the wellbore construction process are inputted to the earth model. An estimate is obtained for a relative geometrical and geological placement of the well path with respect to a geological objective using a trained Kalman filtering agent. An output action based on the sensor measurement for influencing a future profile of the well path with respect to the estimate.

### FIELD OF THE INVENTION

The present invention relates to the field of geosteering and, in particular, to a process for real time geological localization with Kalman filtering for automating geosteering.

### BACKGROUND OF THE INVENTION

In a well construction process, rock destruction is guided by a drilling assembly. The drilling assembly includes sensors and actuators for biasing the trajectory and determining the heading in addition to properties of the surrounding borehole media. The intentional guiding of a trajectory to remain within the same rock or fluid and/or along a fluid boundary, such as an oil/water contact or an oil/gas contact, is known as geosteering.

Geosteering is drilling a horizontal wellbore that ideally is located within or near preferred rock layers. As interpretive analysis is performed while or after drilling, geosteering determines and communicates a wellbore's stratigraphic depth location in part by estimating local geometric bedding structure. Modern geosteering normally incorporates more dimensions of information, including insight from downhole data and quantitative correlation methods. Ultimately, geosteering provides explicit approximation of the location of nearby geologic beds in relationship to a wellbore and coordinate system.

The objective in drilling wells is to maximize the drainage of fluid in a hydrocarbon reservoir. Multiple wells placed in a reservoir are either water injector wells or producer wells. The objective is maximizing the contact of the wellbore trajectory with geological formations that: are more permeable, drill faster, contain less viscous fluid, and contain fluid of higher economical value. Furthermore, drilling more tortuous wells, slower, and out of zone add to the costs of the well.

Geosteering relies on mapping data acquired in the structural domain along the horizontal wellbore and into the stratigraphic depth domain. Relative Stratigraphic Depth (RSD) means that the depth in question is oriented in the stratigraphic depth direction and is relative to a geologic marker. Such a marker is typically chosen from type log data to be the top of the pay zone/target layer. The actual drilling target or “sweet spot” is located at an onset stratigraphic distance from the top of the pay zone/target layer.

In an article by H. Winkler (“Geosteering by Exact Inference on a Bayesian Network” Geophysics 82:5:D279-D291; September-October 2017), machine learning is used to solve a Bayesian network. For a sequence of log and directional survey measurements, and a pilot well log representing a geologic column, a most likely well path and geologic structure is determined.

There remains a need for autonomous geosteering processes with improved accuracy.

### SUMMARY OF THE INVENTION

According to one aspect of the present invention, there is provided a method of geosteering in a wellbore construction process, the method comprising the steps of: providing an earth model defining boundaries between formation layers and petrophysical properties of the formation layers in a subterranean formation comprising data selected from the group consisting of seismic data, data from an offset well and combinations thereof; comparing sensor measurements related to the wellbore construction process to the earth model; obtaining an estimate from the earth model for a relative geometrical and geological placement of the well path with respect to a geological objective using a trained Kalman filtering agent; and determining an output action based on the sensor measurement for influencing a future profile of the well path with respect to the estimate.

### BRIEF DESCRIPTION OF THE DRAWINGS

The method of the present invention will be better understood by referring to the following detailed description of preferred embodiments and the drawings referenced therein, in which:

FIG. 1 illustrates graphically basis functions evaluated as a function of output and RSD;

FIG. 2 illustrates a first derivative of the basis functions of FIG. 1;

FIG. 3 illustrates a B-spline on type log;

FIGS. 4 and 5 illustrate examples of an extended Kalman filter;

FIGS. 6 and 7 illustrate examples of a particle filter;

FIG. 8 illustrates a diagnostic on the chain for the example in FIG. 5;

FIG. 9 illustrates an autocorrelation on the chain for the example in FIG. 5;

FIG. 10 illustrates a posterior distribution for the example in FIG. 5;

FIG. 11 illustrates a diagnostic on the chain for the example in FIG. 4;

FIG. 12 illustrates an autocorrelation on the chain for the example in FIG. 4;

FIG. 13 illustrates a posterior distribution for the example in FIG. 4;

FIGS. 14A and 14B illustrate linear regressions; and

FIG. 15 illustrates an embodiment of the invention where a geosteering problem is formulated as a non-linear state space model.

### DETAILED DESCRIPTION OF THE INVENTION

The present invention provides a method for geosteering in a wellbore construction process. A wellbore construction process can be a wellbore drilling process. The method is advantageously conducted while drilling. The method uses a trained Kalman filtering agent. The method is a computer-implemented method.

In accordance with the present invention, an earth model is provided. The earth model defines boundaries between formation layers and petrophysical properties of the formation layers of a subterranean formation. The earth model is produced from data relating to a subterranean formation, the data selected from the group consisting of seismic data, data from an offset well and combinations thereof. Preferably, the earth model is a 3D model.

The earth model may be a static or dynamic model. Preferably, the earth model is a dynamic model that changes dynamically during the drilling process.

Sensor measurements are inputted to the earth model. The sensor measurements are obtained during the wellbore construction process. Accordingly, real-time sensor measurements are made while drilling. In a real-time drilling process, sensors are chosen based on the geological objectives. if the target reservoir and the surrounding medium can be distinguished by a particular measurement, then this measurement will be chosen. Since there is a limit of the telemetry rate, the sample frequency would also be budgeted. Preferably, the sensor measurements are provided as a streaming sequence. The sensors may be LWD sensors, MWD sensors, image logs, 2D seismic data, 3D seismic data and combinations thereof.

The LWD sensor may be selected from the group consisting of gamma-ray detectors, neutron density sensors, porosity sensors, sonic compressional slowness sensors, resistivity sensors, nuclear magnetic resonance, and combinations thereof.

The MWD sensor is selected from the group consisting of sensors for measuring mechanical properties, inclination, azimuth, roll angles, and combinations thereof.

The earth model simulates the earth and then a sensor measurement from the earth. The simulated sensor measurement is then compared to an actual sensor measurement made while drilling.

A well path is selected to reach a geological objective, such as a geological feature, such as fault, a nearby offset well, a fluid boundary and the like. Examples of fluid boundaries may be oil/water contacts, oil/gas contacts, oil/tar contacts, and the like. An estimate for the relative geometrical and geological placement of a well path to reach the geological objective is obtained using a trained Kalman filtering agent. An output action based on the sensor measurement for influencing a future profile of the well path is determined with respect to the estimate.

In a preferred embodiment, the relative geometrical and geological placement of the well profile is determined by a relative stratigraphic depth (RSD). In this embodiment, the trained Kalman filtering agent matches clustered sensor measurements for the relative stratigraphic depth to a reference measurement with a predetermined set of clusters to discretize the signal for the RSD. A maximum a posteriori probability discretized signal for the RSD is maximized with respect to regularization related to admissible and plausible transitions between adjacent depths and relative geological positions.

A most probable sequence of relative stratigraphic depths is solved by a sampling method selected from the group consisting of mean field, Metropolis-Hastings, Gibbs sampling, Markov chain Monte Carlo and combinations thereof. Preferably, multiple threads of solutions with different initial conditions are solved asynchronously to avoid a local minimum where the most optimal trajectory of the well path is selected.

In a preferred embodiment, the output action of the Kalman filtering agent is determined by maximizing the placement of the well path with respect to a geological datum. An objective is maximizing the contact of the wellbore trajectory with geological formations that: are more permeable, drill faster, contain less viscous fluid, and contain fluid of higher economical value. The geological datum can be, for example, without limitation, a rock formation boundary, a geological feature, an offset well, an oil/water contact, an oil/gas contact, an oil/tar contact and combinations thereof.

The steering of the wellbore trajectories is achieved through a number of different actuation mechanisms, including, for example, rotary steerable systems (RSS) or positive displacement motors. The former contains downhole actuation, power generation feedback control and sensors, to guide the bit by either steering an intentional bend in systems known as point-the-bit or by applying a sideforce in a push-the-bit system. PDM motors contain a fluid actuated Moyno motor that converts hydraulic power to rotational mechanical power for rotating a bit. the motor contains a bend such that the axis of rotation of the bit is offset from the centerline of the drilling assembly. Curved boreholes are achieved through circulating fluid through the motor and keeping the drill-string stationary. Curved boreholes are achieved through rotating the drill string whilst circulating such that the bend cycle averages to obtain a straight borehole.

The output action can be curvature, roll angle, set points for inclination, set points for azimuth, Euler angle, rotation matrix quaternions, angle axis, position vector, position Cartesian, polar, and combinations thereof.

Preferably, the trained Kalman filtering agent uses a non-linear state space model representing a transition of a position and an angle of the subterranean formation, a position and an angle of the well path, and an uncertainty, and propagates the state space model forward in time using a Kalman filter.

The trained Kalman filtering agent may be a trained extended Kalman filtering agent, a trained unscented Kalman filtering agent, a trained particle filtering agent and combinations and derivatives thereof.

Preferably, the trained Kalman filtering agent is a trained particle filtering agent and the particle filter uses a Metropolis-Hasting sampling algorithm.

In another embodiment, the trained Kalman filtering agent is a trained extended Kalman filtering agent and the well path is represented as a b-spline. The trained Kalman filtering agent is differentiated to produce a Jacobian for the extended Kalman filter.

Preferably, the Kalman filtering agent is trained using a simulation environment, more preferably using a simulation environment produced in accordance with the method described in “Method for Simulating a Coupled Geological and Drilling Environment” filed in the USPTO on the same day as the present application, as provisional application U.S. 62/712,490 filed 31 Jul. 2018, the entirety of which is incorporated by reference herein.

For example, the Kalman filtering agent may be trained by (a) providing a training earth model defining boundaries between formation layers and petrophysical properties of the formation layers in a subterranean formation comprising data selected from the group consisting of seismic data, data from an offset well and combinations thereof, and producing a set of model coefficients; (b) providing a toolface input corresponding to the set of model coefficients to a drilling attitude model for determining a drilling attitude state; (c) determining a drill bit position in the subterranean formation from the drilling attitude state; (d) feeding the drill bit position to the training earth model, and determining an updated set of model coefficients for a predetermined interval and a set of signals representing physical properties of the subterranean formation for the drill bit position; (e) inputting the set of signals to a sensor model for producing at least one sensor output and determining a sensor reward from the at least one sensor output; (f) correlating the toolface input and the corresponding drilling attitude state, drill bit position, set of model coefficients, and the at least one sensor output and sensor reward in the simulation environment; and (g) repeating steps b) f) using the updated set of model coefficients from step d).

The drilling model for the simulation environment may be a kinematic model, a dynamical system model, a finite element model, and combinations thereof.

In one embodiment, random variables are defined as shown in Table 1.

TABLE 1

| Variable | Definition | Comments |
|---|---|---|
| yₜ | Wellbore TVD | Partially observed |
| | | (30 m (100 ft)) |
| Żₜ | Geologic dip | Unknown latent |
| | | variable |
| \ddot{Z}ₜ | Geologic changes of | Unknown latent |
| | dip | variable |
| Fₜ | Faulting (a vertical | Unknown but |
| | shifting) | occasionally occur |
| Zₜ | Geologic feature TVD | Unknown latent |
| | | variable |
| Rₜ | Relative | Vertical difference |
| | stratigraphic depth | between Zₜ and Yₜ |
| f | Type well | A non-linear mapping |
| | | from RSD to Gamma |
| mₜ | True earth gamma ray | Observed |

In this embodiment, the model follows a random walk, ignoring the effect of faulting Fₜ and geologic dip Żₜ, as follows:

Zₜ=Zₜ₋₁+ωₜ

Rₜ=Zₜ−yₜ

mₜ=β₁f(Rₜ)+β₀+vₜ

wₜ˜Normal(0,σ_{w}²)

vₜ˜Normal(0,σᵥ²)

which is equivalent to

Zₜ=Zₜ₋₁+ωₜ (1)

mₜ=f(Zₜ−yₜ)+vₜ (2)

wₜ˜Normal(0,σ_{w}²)

vₜ˜Normal(0,σᵥ²)

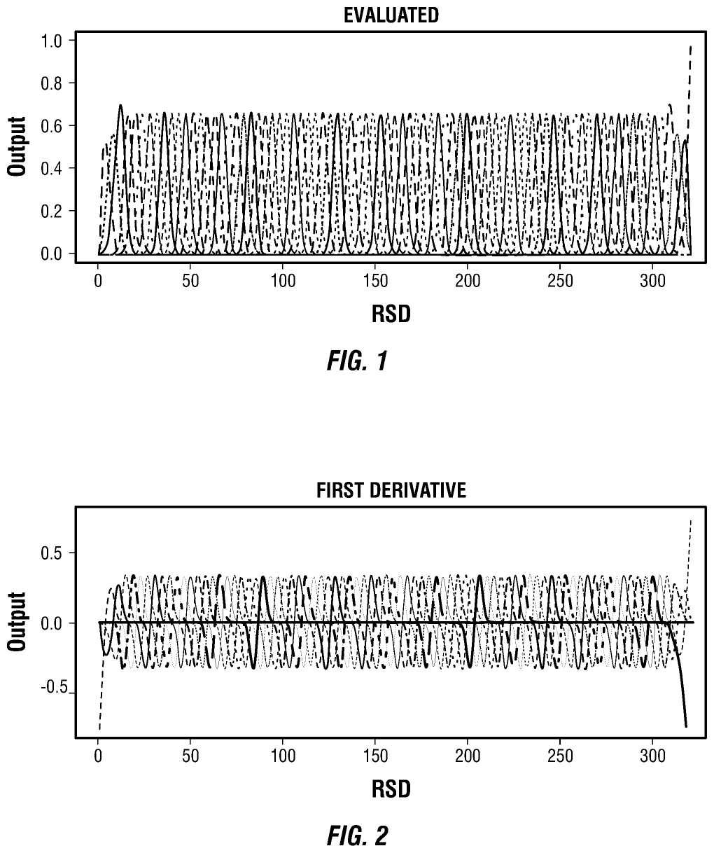

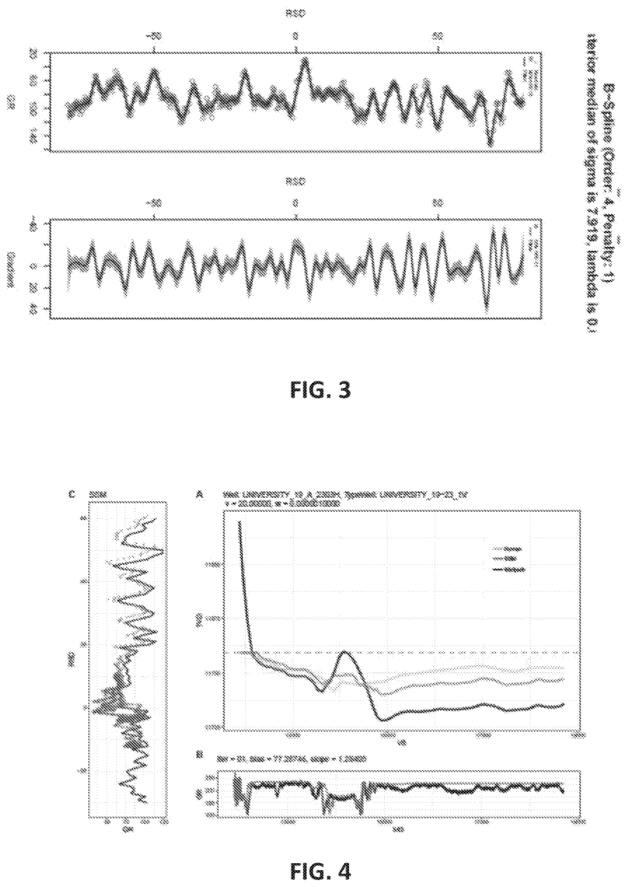

FIG. 1 illustrates graphically basis functions evaluated as a function of output and RSD, while FIG. 2 illustrates a first derivative of the basis functions of FIG. 1. FIG. 3 illustrates a B-spline on type log.

Inference methods for the model include estimation of latent state Zₜ and estimation of other latent parameters, λ_{w}, λᵥ, β₀, β₁. Estimation of latent state Zₜ includes an extended Kalman filter linearizing the non-linear typelog f using a definition of gradient or using b-spline for the gradient. Estimation of latent state Zₜ may also include a particle filter relying on sequential importance sampling or sequential MCMC. Estimation of other latent parameters, λ_{w}, λᵥ, β₀, β₁ may be done with Gibbs sampling.

Table 2 is a comparison of different dynamic models.

TABLE 2

| Name | Example | p(xₜ\|xₜ₋₁) | p(yₜ\|xₜ) | p(x₁) |
|---|---|---|---|---|
| Discrete | HMM | Aₓ_{_{t−1}}ₓ_{ₜ} | Any or B_{y}_{ₜ}ₓ_{ₜ} | π |
| state DM | | | | |
| Linear | Kalman | N (Aₓ_{_{t−1}} + B, | N (Hₓ_{ᵢ} + C, | N (x₁; μ, ϵ) |
| Gaussian DM | | Q) | R) | |
| Non-Linear | Particle | f (xᵢ₋₁) | g (xₜ) | f₀ (x₁) |
| Non-Gaussian | | | | |
| DM | | | | |

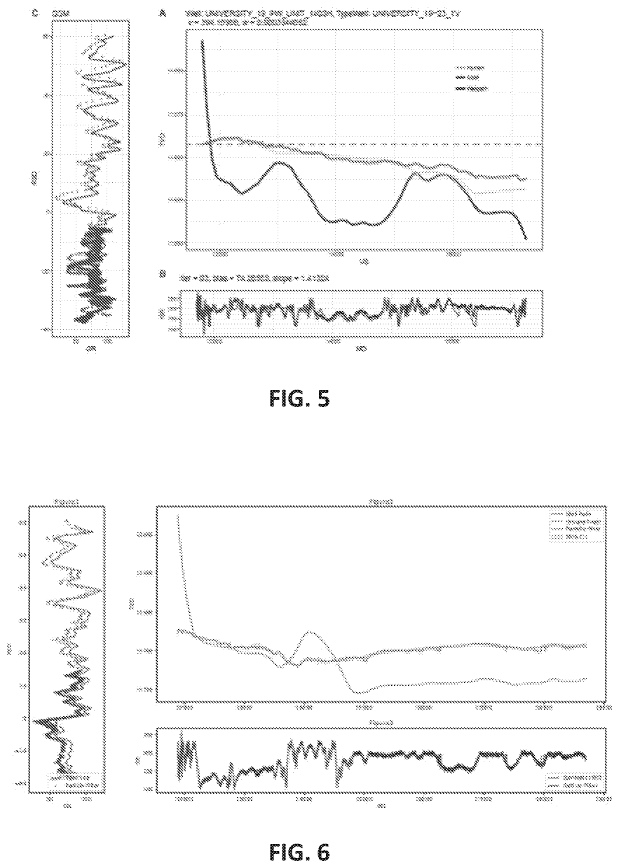

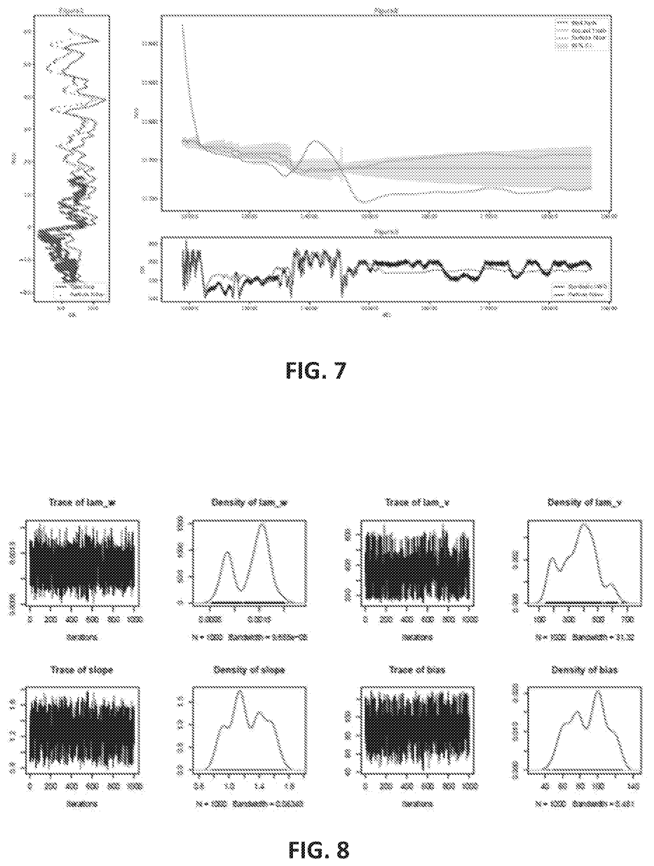

FIGS. 4 and 5 illustrate examples of an extended Kalman filter, while FIGS. 6 and 7 illustrated examples of a particle filter.

A hierarchical Gibbs model for geosteering is:

Zₜ=Zₜ−ωₜ

mₜ=β₁f(Zₜ−yₜ)+β₀+vₜ

wₜ˜Normal(0,λ_{ω}⁻¹)

vₜ˜Normal(0,λᵥ⁻¹)

where β₁ is a scaling factor, β₀ is a baseline term, λ_{ω} and λᵥ are the precision parameters for the latent equation and observation equation, and f is the typelog function given by the interpolation. The likelihood function is:

p(m|Z,a,b)=p(Z₀)Πₜ₌₁^{T}p(Zₜ|Zₜ₋₁)p(mₜ|Zₜ).

Then the joint likelihood can be expressed as:

$$p ( m \vert Z , a , b ) = {λ}_{ω}^{\frac{T}{2}} {λ}_{v}^{\frac{T}{2}} exp ( - \frac{1}{2} {λ}_{ω} {\sum }_{t = 1}^{T} {( {Z}_{t} - {Z}_{t - 1} )}^{2} - \frac{1}{2} {λ}_{v} {\sum }_{t = 1}^{T} {( {m}_{t} - [ 1 , {\hat{m}}_{t} ] [ \begin{matrix}{β}_{0} \\ {β}_{1}\end{matrix} ] )}^{2} )$$

[β₀, β₁]^{T} is denoted as β and [1,\hat{m}ₜ]⁷ₜ₌₁^{T} is denoted as M. Using the following:

λ_{w}˜Gamma(α_{ω},β_{ω})

λᵥ˜Gamma(αᵥ,βᵥ)

f(β)∝1

Hyper-parameters are set to be:

∝_{ω}=β_{ω}=∝ᵥ=βᵥ=0.01

### Updating for β:

p(β| . . . )∝exp(−1/2λᵥ(m−β)^{T}(m−Mβ))

∝exp(λᵥβ^{T}M^{T}m−1/2λᵥβ^{T}M^{T}Mβ)

which are recognized as the kernel for multivariate normal distribution

$$[ β \vert \text{…} ] \text{∼} M V N ( {μ}_{β ,} {Σ}_{β} ) \\ {Σ}_{β} = \frac{1}{{λ}_{v}} {( {M}^{T} M )}^{- 1} \\ {μ}_{β} = {( {M}^{T} M )}^{- 1} {M}^{T} m \qquad ( 3 )$$

Updating the rule for λ_{w}:

$$p ( {λ}_{ω} \vert … ) ∝ {λ}_{ω}^{\frac{T + 2 {α}_{ω}}{2} - 1} exp ( - \frac{1}{2} {λ}_{ω} ( {\sum }_{t = 1}^{T} {( {Z}_{t} - {Z}_{t - 1} )}^{2} + 2 {β}_{ω} ) )$$

### Therefore,

$$[ {λ}_{ω} \vert \text{…} ] \text{∼} Gamma ( \frac{T}{2} + {α}_{ω} , \frac{1}{2} {\sum }_{t = 1}^{T} {( {Z}_{t} - {Z}_{t - 1} )}^{2} + {β}_{ω} ) \\ {μ}_{β} = {( {M}^{T} M )}^{- 1} {M}^{T} m \qquad ( 4 )$$

Updating the rule for λᵥ:

$$p ( {λ}_{v} \vert … ) ∝ {λ}_{v}^{\frac{T + 2 {α}_{v}}{2} - 1} exp ( - \frac{1}{2} {λ}_{v} ( {\sum }_{t = 1}^{T} {( {m}_{t} - {M}_{t} β )}^{2} + 2 {β}_{v} ) )$$

### Therefore,

$$[ {λ}_{v} \vert \text{…} ] \text{∼} Gamma ( \frac{T}{2} + {α}_{v} , \frac{1}{2} {\sum }_{t = 1}^{T} {( {m}_{t} - {M}_{t} β )}^{2} + {β}_{v} ) \qquad ( 5 )$$

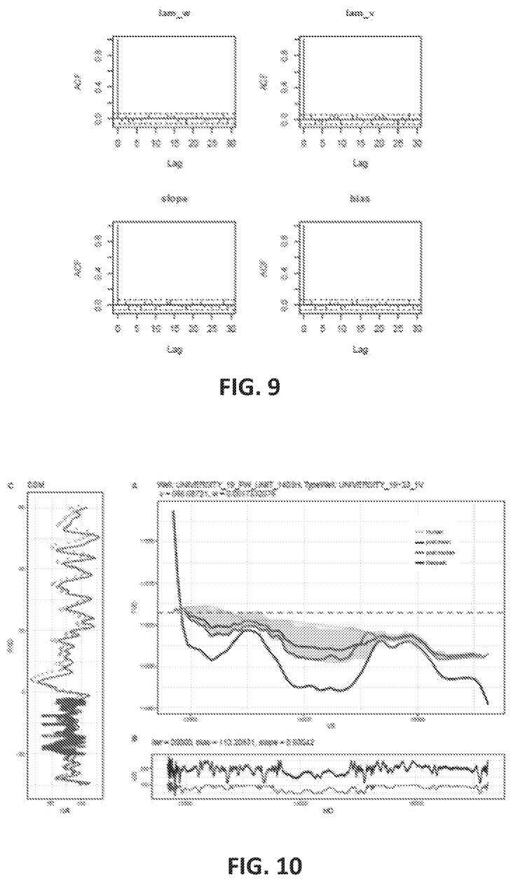

FIG. 8 illustrates a diagnostic on the chain for the example in FIG. 5, while FIG. 9 illustrates an autocorrelation on the chain and FIG. 10 illustrates a posterior distribution.

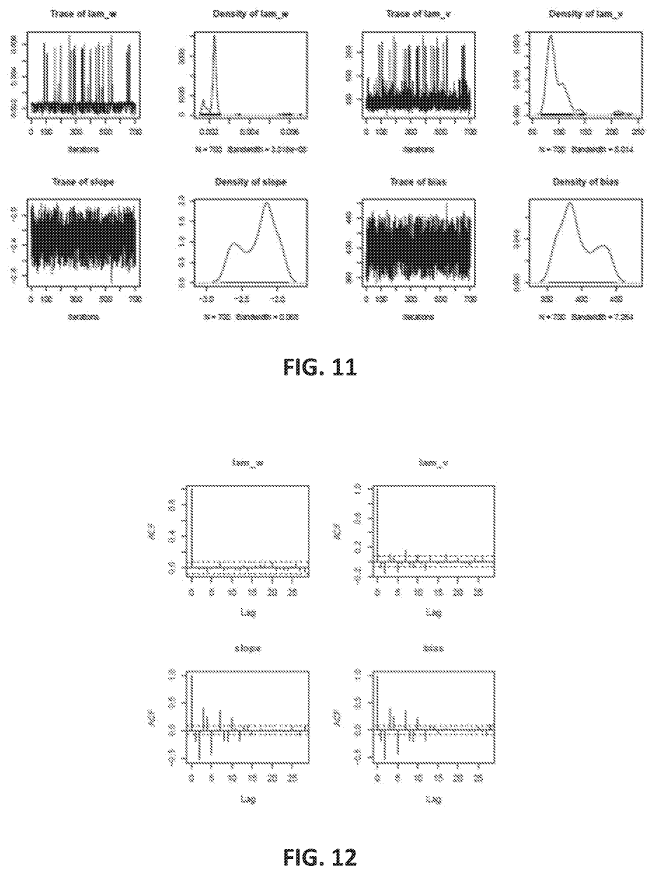

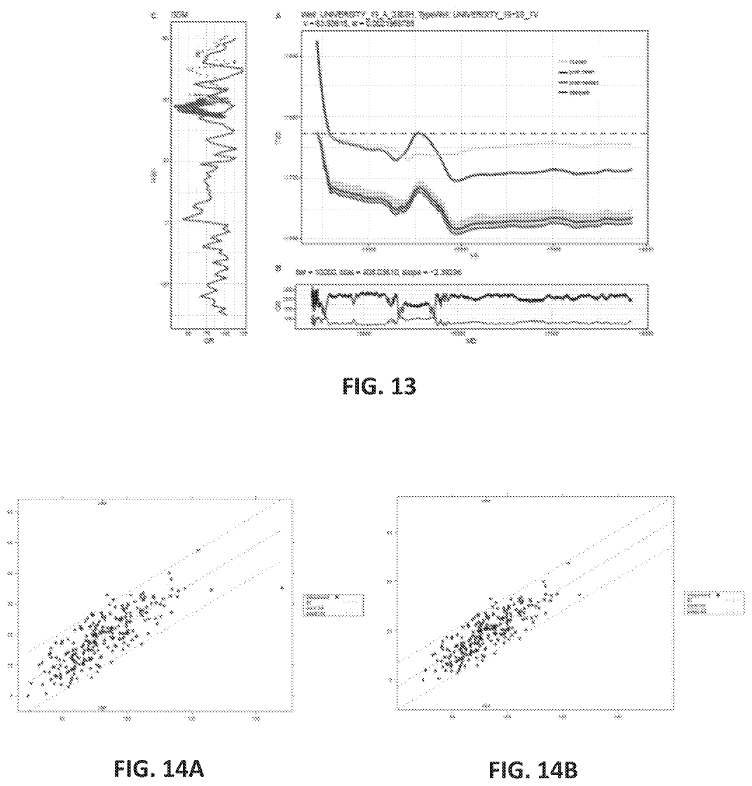

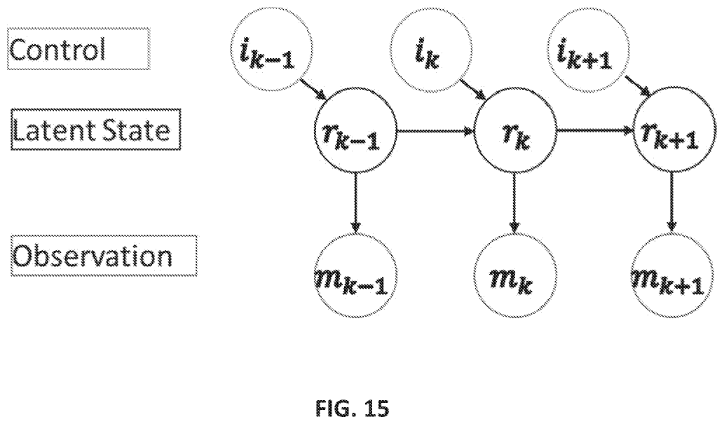

FIG. 11 illustrates a diagnostic on the chain for the example in FIG. 4, while FIG. 12 illustrates an autocorrelation on the chain and FIG. 13 illustrates a posterior distribution.

FIGS. 14A and 14B illustrate linear regressions. In FIG. 14A, outliers are shown, while outliers are removed in FIG. 14B.

Using a robust linear regression with heavy tailed error distributions:

$${y}_{i} {∼}^{ind} t ( v , {x}_{i}^{T} β , 1 \text{/} ϕ )$$

$$L ( β , ϕ ) ∝ {\prod }_{t = 1}^{n} {{ϕ}^{1 / 2} ( 1 + \frac{{ϕ ( {y}_{i} - {x}_{i}^{T} β )}^{2}}{v} )}^{- \frac{v + 1}{2}}$$

and imposing:

p(β,ϕ)∝1/ϕ,

the posterior distribution is

$$p ( β , ϕ \vert y ) ∝ {ϕ}^{n / 2 - 1} {\prod }_{t = 1}^{n} {( 1 + \frac{{ϕ ( {y}_{i} - {x}_{i}^{T} β )}^{2}}{v} )}^{- \frac{v + 1}{2}}$$

with no closed formed expressions.

Scale-mixtures of normal representation:

$$\begin{matrix}{Z}_{i} {∼}^{iid} t ( v , 0 , 1 \text{/} ϕ ) \\ ⇔ \\ {Z}_{i} \vert {λ}_{i} {∼}^{ind} Normal ( 0 , 1 \text{/} ( {λ}_{i} ϕ ) ) \\ {λ}_{i} {∼}^{iid} Gamma ( v \text{/} 2 , v \text{/} 2 )\end{matrix}$$

Integrating out the “latent” λᵢs, the marginal t distribution is obtained. The robust regression for a linear model can be written as:

$$\begin{matrix}{Z}_{i} {∼}^{iid} t ( v , 0 , 1 \text{/} ϕ ) \\ ⇔ \\ {Z}_{i} \vert {λ}_{i} {∼}^{ind} Normal ( 0 , 1 \text{/} ( {λ}_{i} ϕ ) ) \\ {λ}_{i} {∼}^{iid} Gamma ( v \text{/} 2 , v \text{/} 2 )\end{matrix}$$

Then the joint posterior distribution is:

$$p ( β , ϕ , λ \vert y ) ∝ {ϕ}^{n / 2 - 1} exp \{ - \frac{1}{2} ϕ {\sum }_{t = 1}^{n} {{λ}_{i} ( {y}_{i} - {x}_{i}^{T} β )}^{2} \} \times {\prod }_{i = 1}^{n} {λ}_{i}^{v / 2 - 1} exp ( - {λ}_{i} v \text{/} 2 ) ∝ {ϕ}^{n / 2 - 1} exp ( - \frac{1}{2} ϕ {β}^{T} {X}^{T} diag ( λ ) X β + ϕ {y}^{T} diag ( λ ) X β - ϕ {y}^{T} diag ( λ ) y ) \times {\prod }_{i = 1}^{n} {λ}_{i}^{v / 2} exp ( - {λ}_{i} v \text{/} 2 )$$

Updating for β:

$$[ β \vert \text{...} ] \text{∼} ( {μ}_{β} , {Σ}_{β} )$$

$${Σ}_{β} = \frac{1}{ϕ} {( {X}^{T} diag ( λ ) X )}^{- 1}$$

$${μ}_{β} = {( {X}^{T} diag ( λ ) X )}^{- 1} {X}^{T} diag ( λ ) y$$

Updating for ϕ:

$$p ( ϕ \vert \text{...} ) ∝ {ϕ}^{n / 2 - 1} exp \{ - \frac{1}{2} ϕ {\sum }_{i = 1}^{n} {{λ}_{i} ( {y}_{i} - {x}_{i}^{T} β )}^{2} \} \\ [ ϕ \vert \text{...} ] \text{∼} Gamma ( \frac{n}{2} , \frac{1}{2} {\sum }_{i = 1}^{n} {{λ}_{i} ( {y}_{i} - {x}_{i}^{T} β )}^{2} )$$

Updating for λᵢ, i∈{1, 2, . . . , n}:

$$p ( {λ}_{i} \vert \text{...} ) ∝ exp ( - {λ}_{i} \frac{1}{2} \{ {ϕ ( {y}_{i} - {x}_{i}^{T} β )}^{2} + v \} ) {λ}_{i}^{v / 2 - 1} \\ [ {λ}_{i} \vert \text{...} ] \text{∼} Gamma ( \frac{v}{2} , \frac{1}{2} \{ {ϕ ( {y}_{i} - {x}_{i}^{T} β )}^{2} + v \} )$$

For particle filter:

Latent: p(xₜ|xₜ₋₁)=f(xₜ₋₁)

Observation: p(yₜ|xₜ)=g(xₜ)

P(x₀)=f₀(x₀)

To compute [symbol] [f(X)] where X˜p(X), where p(X) can be sampled. Monte Carlo can be used to approximate the integral, where

$${X}^{( 1 )} , {X}^{( 2 )} , … , {X}^{( n )} {∼}^{iid} P ( X )$$

$$𝔼 [ f ( X ) ] = {\int }_{X} f ( X ) d x \approx \frac{1}{N} {\sum }_{i = 1}^{N} f ( {X}^{( i )} )$$

Where p(X) cannot be sampled, important sampling can be used assuming a relatively simple q(X) can be sampled, whose support shares the same as p(X).

$${\int }_{X} \underbrace{f ( x ) \frac{p ( x )}{q ( x )}}_{g ( x )} q ( x ) d x \approx \frac{1}{N} {\sum }_{i = 1}^{N} f ( {X}^{( i )} ) \underbrace{\frac{p ( {X}^{( i )} )}{q ( {X}^{( i )} )}}_{{ω}_{i}}$$

where iid N points X⁽¹⁾, . . . , X^{(N)} are sampled from q(X) and ωᵢ is the ith importance weight.

Sequential Importance Sampling (SIS) can be used to sample X_{1:N} when it is difficult to come up with a suitable N dimensional proposal distribution for sampling from an N dimensional random variable γ(X_{1:N}):

$$ω ( {X}_{1 : N}^{( i )} ) = \frac{γ ( {X}_{1 : N}^{( i )} )}{q ( {X}_{1 : N}^{( i )} )}$$

An SIS recursive definition can be found:

$$\begin{matrix}ω ( {X}_{1 : N} ) = \frac{γ ( {X}_{1 : N} )}{q ( {X}_{1 : N} )} \\ = \frac{γ ( {X}_{1 : N} )}{q ( {X}_{N} \vert {X}_{1 : n - 1} ) q ( {X}_{1 : n - 1} )} \times \frac{γ ( {X}_{1 : n - 1} )}{γ ( {X}_{1 : n - 1} )} \\ = ω ( {X}_{1 : n - 1} ) ( \frac{γ ( {X}_{1 : N} )}{q ( {X}_{n} \vert {X}_{1 : n - 1} ) γ ( {X}_{1 : n - 1} )}\end{matrix}$$

Applying SIS to particle filter, given γ(x_{1:t})=p(x_{1:t},y_{1:t}),

$$\begin{matrix}ω ( {x}_{1 : t} ) = ω ( {x}_{1 : t - 1} ) \frac{γ ( {x}_{1 : t} )}{q ( {x}_{t} \vert {x}_{1 : t - 1} ) γ ( {x}_{1 : t - 1} )} \\ = ω ( {x}_{1 : t - 1} ) \frac{p ( {y}_{t} \vert {x}_{1 : t} , {y}_{1 : t - 1} ) p ( {x}_{1 : t} , {y}_{1 : t - 1} )}{q ( {x}_{t} \vert {x}_{1 : t - 1} ) γ ( {x}_{1 : t - 1} )} \\ = ω ( {x}_{1 : t - 1} ) \frac{p ( {y}_{t} \vert {x}_{t} ) p ( {x}_{1 : t} , {y}_{1 : t - 1} )}{q ( {x}_{t} \vert {x}_{1 : t - 1} ) γ ( {x}_{1 : t - 1} )} \\ = ω ( {x}_{1 : t - 1} ) \frac{p ( {y}_{t} \vert {x}_{t} ) p ( {x}_{t} \vert {x}_{1 : t - 1} , {y}_{1 : t - 1} ) p ( {x}_{1 : t - 1} , {y}_{1 : t - 1} )}{q ( {x}_{t} \vert {x}_{1 : t - 1} ) γ ( {x}_{1 : t - 1} )} \\ = ω ( {x}_{1 : t - 1} ) \frac{p ( {y}_{t} \vert {x}_{t} ) p ( {x}_{t} \vert {x}_{t - 1} ) \overbrace{p ( {x}_{1 : t - 1} , {y}_{1 : t - 1} )}^{γ ( {x}_{1 : t - 1} )}}{q ( {x}_{t} \vert {x}_{1 : t - 1} ) γ ( {x}_{1 : t - 1} )} \\ = ω ( {x}_{1 : t - 1} ) \frac{p ( {y}_{t} \vert {x}_{t} ) p ( {x}_{t} \vert {x}_{t - 1} )}{q ( {x}_{t} \vert {x}_{1 : t - 1} )}\end{matrix}$$

Given samples from the proposal distribution xₜ⁽ⁱ⁾˜q(xₜ|x_{1:t-1}⁽ⁱ⁾), then the importance weights are updated by:

$${ω}^{( i )} ( {x}_{1 : t} ) = {ω}^{( i )} ( {x}_{1 : t - 1} ) \frac{p ( {y}_{t} \vert {x}_{t}^{( i )} ) p ( {x}_{t}^{( i )} \vert {x}_{t - 1}^{( i )} )}{q ( {x}_{t}^{( i )} \vert {x}_{1 : t - 1}^{( i )} )} \qquad ( 6 )$$

Using the transitional proposal directly as the proposal:

q(xₜ|x_{1:(t-1)}) [symbol] p(xₜ|xₜ₋₁)

The updating factor is refined as:

$$\frac{p ( {y}_{t} \vert {x}_{t} ) p ( {x}_{t} \vert {x}_{t - 1} )}{p ( {x}_{t} \vert {x}_{t - 1} )} = p ( {y}_{t} \vert {x}_{t} )$$

And the new weights update formula is:

ω⁽ⁱ⁾(x_{1:t})=ω⁽ⁱ⁾(x_{1:t-1})p(yₜ|xₜ⁽ⁱ⁾

where xₜ⁽ⁱ⁾˜p(xₜ|xₜ₋₁).

When t=1: for each particle i∈{1, 2, . . . , N},

$$\begin{matrix}{x}_{1}^{( i )} \text{∼} {f}_{0} ( {x}_{1} ) & Sample \\ {ω}_{1}^{( i )} ( {x}_{1} ) = g ( {x}_{1}^{( i )} ) & Weights \\ {\hat{ω}}_{t}^{( i )} ( {x}_{1} ) = \frac{{ω}_{t}^{( i )} ( {x}_{1} )}{{\sum }_{j} {ω}_{t}^{( j )} ( {x}_{1} )} & Normalize\end{matrix}$$

When t=t where 2≤t≤T: for each particle i∈{1, 2, . . . , N},

$$\begin{matrix} {x}_{t}^{( i )} \text{∼} p ( {x}_{t} \vert {x}_{t - 1}^{( i )} ) & Sample \\ \begin{matrix}{ω}_{t}^{( i )} ( {x}_{1 : t} ) = {ω}_{t}^{( i - 1 )} ( {x}_{1 : t - 1} ) p ( {y}_{t} \vert {x}_{t}^{( i )} ) \\ = {ω}_{t}^{( i - 1 )} ( {x}_{1 : t - 1} ) g ( {x}_{t}^{( i )} )\end{matrix} & Weights \\ {\hat{ω}}_{t}^{( i )} ( {x}_{1 : t} ) = \frac{{ω}_{t}^{( i )} ( {x}_{1 : t} )}{{\sum }_{j} {ω}_{t}^{( j )} ( {x}_{1 : t} )} & Normalize\end{matrix}$$

SIS can suffer from a degeneracy problem. It starts with uniformly distributed particles with equal weights. There may be only a handful of particles near the true latent states.

As the algorithm runs, any particle that does not match the measurements will acquire an extremely low weight. Only the particle near the truth will have an appreciable weight. Accordingly, it is possible to have 5000 particles with only 3 contributing meaningfully to the state estimation.

By incorporating resampling, particles with very low probability are discarded and replaced with new particles with higher probability, by duplicating particles with relatively high probability. A resampling step is illustrated below:

Resampling: j˜ω(x_{1:t-1}⁽ⁱ⁾)

Sample: xₜ⁽ⁱ⁾˜q(xₜ|xₜ₋₁⁽ⁱ⁾^{^{j}}

Weight:

$$ω ( {x}_{1 : t}^{( i )} ) = ω ( {x}_{1 : t - 1}^{( i )} ) \frac{\begin{matrix}p ( {y}_{t} \vert {x}_{t}^{( i )} ) \\ p ( {x}_{t}^{( i )} \vert {x}_{t - 1}^{( i ) j} )\end{matrix}}{\begin{matrix}ω ( {x}_{1 : t - 1}^{( t )} ) \\ q ( {x}_{t}^{( i )} \vert {x}_{t - 1}^{{( i )}^{j}} )\end{matrix}} = \frac{p ( {y}_{t} \vert {x}_{t}^{( i )} ) p ( {x}_{t}^{( i )} \vert {x}_{t - 1}^{( i ) j} )}{q ( {x}_{t}^{( i )} \vert {x}_{t - 1}^{( i ) j} )} = p ( {y}_{t} \vert {x}_{t}^{( i )}$$

Normalize: ω(x_{1:t}⁽¹⁾), ω(x_{1:t}⁽²⁾), . . . , ω(x_{1:t}^{(N)}),

where (i)^{j} means that the position of sample i moves to the position of sample j.

Referring to FIG. 39, a Geosteering problem is formulated as a non-linear State Space Model (SSM). RSD is updated using the wellbore inclination and an error term (called innovation) Θₜ. Then we impose a mean zero and precision parameter λ_{w} normal prior on Θₜ, and use this to model the noisy observed inclination data and the unknown formation dip angle αₜ.

For the observation model (2), we associate the correlation between the type log and LWD log. Type log is from a pilot vertical well which penetrates all the formations of our interest. The type log is treated as a mapping of RSD to Gamma Ray or as a non-linear function. To account for the difference in the Gamma ray sensor between the type log and LWD log, we use β₁ and β₀ as the scaling and shifting parameter. In the observation model (2), vₜ is used to model the errors due to the sensing error from which we also impose a mean zero and precision λᵥ normal distribution.

The estimations for the SSM comes from two parts: the latent state Rₜ and the other hyper-parameters such as β₀, β₁, λᵥ and λ_{w}. For estimation of the latent state Rₜ, we can use extended Kalman filter, unscented Kalman filter and particle filter. Using any one of those three, a trajectory of {Rₜ}ₜ^{{T}} can be estimated. Given this trajectory, the remaining job is to estimate the hyper-parameter, and using Gibbs sampling or Metropolis Hastings to obtain the sampling distributions. The inference part for the Gibbs sampling is done via equations from (3) to (6).

While preferred embodiments of the present disclosure have been described, it should be understood that various changes, adaptations and modifications can be made therein without departing from the spirit of the invention(s) as claimed below.

1. A method of geosteering in a wellbore construction process, the method comprising the steps of:
providing an earth model defining boundaries between formation layers and petrophysical properties of the formation layers in a subterranean formation comprising data selected from the group consisting of seismic data, data from an offset well and combinations thereof;
comparing sensor measurements related to the wellbore construction process to the earth model;
obtaining an estimate from the earth model for a relative geometrical and geological placement of the well path with respect to a geological objective using a trained Kalman filtering agent; and
determining an output action based on the sensor measurement for influencing a future profile of the well path with respect to the estimate.

2. The method of claim 1, wherein the trained Kalman filtering agent uses a non-linear state space model representing a transition of a position and an angle of the subterranean formation, a position and an angle of the well path, and an uncertainty, and propagates the state space model forward in time using a Kalman filter.

3. The method of claim 1, wherein the trained Kalman filtering agent is selected from the group consisting of a trained extended Kalman filtering agent, a trained unscented Kalman filtering agent, a trained particle filtering agent and combinations and derivatives thereof.

4. The method of claim 3, wherein the trained Kalman filtering agent is a trained particle filtering agent and the particle filter uses a Metropolis-Hasting sampling algorithm.

5. The method of claim 3, wherein the trained Kalman filtering agent is a trained extended Kalman filtering agent and the well path is represented as a b-spline, and differentiating to produce a Jacobian for the extended Kalman filter.

6. The method of claim 1, wherein the earth model is a static model.

7. The method of claim 1, wherein the earth model is a dynamic model that changes dynamically during the drilling process.

8. The method of claim 1, wherein the sensor measurements are provided as a streaming sequence.

9. The method of claim 1, wherein the sensor measurements are measurements obtained from sensors selected from the group consisting of gamma-ray detectors, neutron density sensors, porosity sensors, sonic compressional slowness sensors, resistivity sensors, nuclear magnetic resonance, mechanical properties, inclination, azimuth, roll angles, and combinations thereof.

10. The method of claim 1, wherein the Kalman filtering agent is trained in a simulation environment.

11. The method of claim 10, wherein the simulation environment is produced by a training method comprising the steps of:
a) providing a training earth model defining boundaries between formation layers and petrophysical properties of the formation layers in a subterranean formation comprising data selected from the group consisting of seismic data, data from an offset well and combinations thereof, and producing a set of model coefficients;
b) providing a toolface input corresponding to the set of model coefficients to a drilling attitude model for determining a drilling attitude state;
c) determining a drill bit position in the subterranean formation from the drilling attitude state;
d) feeding the drill bit position to the training earth model, and determining an updated set of model coefficients for a predetermined interval and a set of signals representing physical properties of the subterranean formation for the drill bit position;
e) inputting the set of signals to a sensor model for producing at least one sensor output and determining a sensor reward from the at least one sensor output;
f) correlating the toolface input and the corresponding drilling attitude state, drill bit position, set of model coefficients, and the at least one sensor output and sensor reward in the simulation environment; and
g) repeating steps b)-f) using the updated set of model coefficients from step d).

12. The method of claim 11, wherein the drilling attitude model is selected from the group consisting of a kinematic model, a dynamical system model, a finite element model, and combinations thereof.

13. The method of claim 1, wherein the output action is determined by maximizing the placement of the well path with respect to a geological datum.

14. The method of claim 13, wherein the geological datum is selected from the group consisting of a rock formation boundary, a geological feature, an offset well, an oil/water contact, an oil/gas contact, an oil/tar contact and combinations thereof.

15. The method of claim 1, wherein the output action is selected from the group consisting of curvature, roll angle, set points for inclination, set points for azimuth, Euler angle, rotation matrix quaternions, angle axis, position vector, position Cartesian, polar, and combinations thereof.
